(19) United States
(12) Patent Application Publication
(10) Pub. No.: US 2008/0245867 A1
(43) Pub. Date: Oct. 9, 2008

(54) Reader and a Method of Activating a Reader

(76) Inventor: Gerhard Stephanus Mynhardt, Sandton (ZA)

Correspondence Address: FROMMER LAWRENCE & HAUG, 745 FIFTH AVENUE- 10TH FL., NEW YORK, NY, 10151, US

(21) Appl. No.: 11/912,018

(22) PCT Filed: Feb. 20, 2006
(86) PCT No.: PCT/IB06/00328

§ 371 Date: Apr. 28, 2008

(30) Foreign Application Priority Data
Apr. 21, 2005 (ZA) 2005/03228

(51) Int. Cl. G06K 7/10

(52) U.S. Cl. 235/462.01

(57) ABSTRACT

A reader such as a bar code or RFID reader includes a housing and at least one force sensor. A reading module located in the housing includes a processor connected to the at least one force sensor to activate a read cycle when the at least one force sensor senses an applied force above a predetermined threshold.

### BACKGROUND

THIS invention relates to a reader such as a bar code reader or a Radio Frequency Identification (RFID) reader.

In these kinds of readers a read cycle is triggered with the user pulling a trigger on a gun-like handle grip or pressing a button mounted on the reader.

When pressed, this effects the reading of a bar code or RFID tag.

The present invention seeks to provide an improved reader particularly with an improved mechanism to start a read cycle.

### SUMMARY

In one example embodiment there is provided a reader including:
a housing;
at least one force sensor;
a reading module located in the housing, the reading module including a processor connected to the at least one force sensor to activate a read cycle when the at least one force sensor senses an applied force above a predetermined threshold.

The reader may include a plurality of force sensors.

The housing may have a handle and wherein the sensors are located at various positions around the handle.

Alternatively, the sensors may be located at various positions around the housing.

The at least one sensor may be located beneath a layer of material such as rubber or plastic.

In one example, at least one other force sensor is used to sense an applied force above a predetermined threshold and wherein the processor, in response to the detection of the applied force executes another function.

In another example, at least one other force sensor is used to sense an applied force above a predetermined threshold and wherein the processor, in response to the detection of an applied force simultaneously on more than one of the sensors executes another function.

The other function may be at least one of: barcode read, RFID read, short range read and long range read.

The at least one force sensors could be a force resistor or an air pressure sensor.

In one example, the processor runs a calibration cycle to determine the output from the at least one sensor when a force is applied to the sensor.

The reader may be a bar code reader or an RFID reader.

The handle may have two parts with a space between them and wherein the at least one sensor is placed in the space so that a force applied to the handle is transmitted through the two handle parts to the at least one sensor.

In a further example, a method of activating a reader includes:
receiving a signal at a processor from at least one force sensor;
using the received signal to determine if a force applied to the at least one force sensor is above a predetermined threshold; and
if the force applied to the at least one force sensor is above the predetermined threshold, then activating the reader.

The reader may be activated to complete a read cycle.

The reader may include a plurality of force sensors and wherein the processor, in response to the detection of an applied force on one of the sensors executes a function.

In addition, the processor, in response to the detection of an applied force simultaneously on more than one of the sensors executes a function.

The function may be at least one of: barcode read, RFID read, short range read and long range read.

### BRIEF DESCRIPTION OF THE DRAWINGS

FIG. 1 shows a prior art reader;

FIG. 2 is a view of the handle of a reader according to one example embodiment;

FIG. 3 shows a cross section through a part of the wall of the reader of FIG. 2;

FIG. 4 shows a cross section through line 4-4 of FIG. 2;

FIG. 5 is a schematic diagram of a circuit for use with example embodiment;

FIG. 6 is a view of the handle of a reader according to a second embodiment; and

FIG. 7 is a view of the handle of a reader according to a third embodiment.

### DESCRIPTION OF PREFERRED EMBODIMENTS

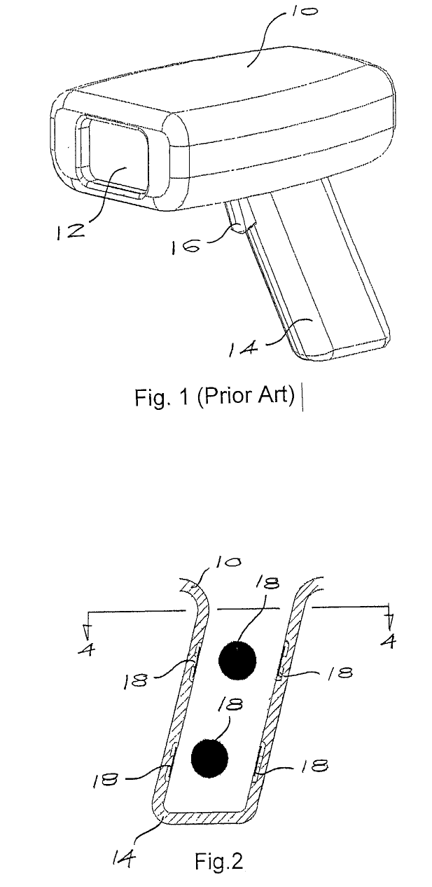

FIG. 1 illustrates a typical prior art bar code reader. The reader consists of a housing 10 with a window 12 through which the bar code is read.

A handle 14 includes a trigger 16 thereon.

To begin a read cycle the trigger 16 is depressed typically using the index finger of the operator.

Referring to FIGS. 2-4, a reader also comprises a housing 10 with a reading module (not illustrated in FIG. 2) located inside the housing.

At least one, but typically a plurality, of force sensors 18 are located at positions on the housing which will be held by a user when using the reader.

In FIG. 2 the force sensors 18 are located at various positions around the handle 14.

The reader handle 14 will typically be constructed from a rigid plastic material 20 and will be enclosed in a softer rubber material 22 or another suitable material such as a soft plastic.

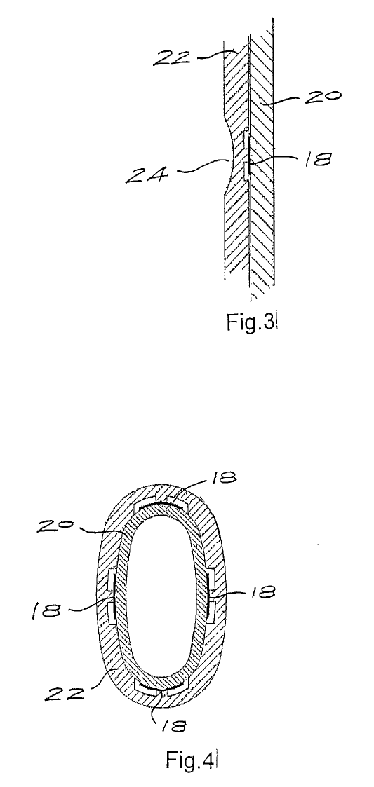

In the embodiment illustrated in FIG. 3 the force sensor 18 is located beneath the rubber layer 22 which has a finger indent guide 24 located therein.

FIG. 4 is a cross section along lines 4-4 of FIG. 2 in which the location of the sensors 18 around the handle 14 can clearly be seen.

It will be appreciated that this is one example of where the force sensors can be located but that various alternatives of the location of the force sensors could be used.

In addition, it will be appreciated that where the reader does not have a handle as such but where the body of the reader is held by a user, force sensors will be located on the body of the reader where it will be held.

Because the illustrated embodiment uses a plurality of force sensors, the embodiment will have the advantage of allowing sensing of finger pressure or force in different parts of the handle, which can then be used to derive a number of different input conditions.

For example, a full hand grip via all fingers gripping tighter around the handle, thumb pressure, index pressure or small finger presser may effect different commands.

The placing of the sensor around the handle will allow for differentiation of such pressure for either left or right handed users. Once the pressure or force has been detected through the combination of sensors, electronics, analog to digital conversion, and the relevant software routines, the software can differentiate between the different sensor inputs, resulting in a variety of different control codes. This can be used to activate different functions, such as barcode read, RFID read, short range read, long range read etc.

In any event, it will be noted from FIG. 4 that the rubber 22 presses down on the force sensor without touching the edges of the sensing area in order to increase sensitivity.

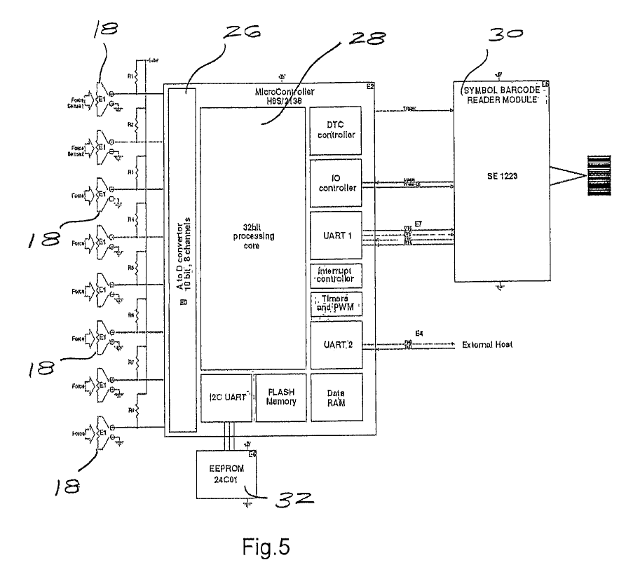

FIG. 5 illustrates the electronic components of an example embodiment.

A plurality of sensors 18 are connected to an analogue to digital converter 26.

A reading module includes processor 28 and bar code reader module 30, for example.

The processor 28 may be a Hitachi HS 2138 microprocessor which is connected to the force sensors via the analogue to digital converter.

This particular processor also includes an integrated flash programme memory, a data memory and an interface port to allow interfacing to the attached bar code reader module 30.

The bar code reader module 30 is used to undertake the actual bar code reading and decoding and may be a symbol SE 1223 module, for example.

The interface between the microprocessor 28 and the module 30 is E7, which includes a trigger/scan signal and serial data signal in order to communicate asynchronously with the module 30. This module 30 receives a trigger signal from the microprocessor 28 once force has been detected. It then scans for barcodes for as long as the force is detected, or until a barcode has been successfully read. The decoded barcode data is thereupon transmitted to the processor.

Each force sensor 18 in the illustrated example is a force sense resistor which is connected from ground to a pull up resistor, in this case a resistor with a value of 330K ohms. The force sense resistor 18 is nearly open circuit when no force is applied. When force is applied the resistance drops to a typical value between 100K ohms and down to 20 K ohms for higher force levels. The force resistance change is sensed by sensing the voltage level at the junction of resistor R1 and the force sense resistor at the input of the analog to digital converter 26. The resistor R1 is connected to the 5 volts supply, and to the force sense resistor 18, thereby resulting in the changing voltage levels at the analog to digital converter as the sensed force changes.

A calibration cycle will be used to determine the various voltage levels detected when various finger or hand forces or pressures are applied. The software routines sense the various sensor voltages for no pressure/force, and full pressure/force applied. The relevant voltage levels are saved for each sensor in an EEPROM (electrically erasable programmable read only memory) 32. This non-volatile memory, typically being a 24C01 type able to store 128 bytes of data, will retain the various voltages, even if power is fully removed to the circuitry, and re-applied at a later stage used for calibration purposes. During a scan the measured sensor voltages are compared to the calibrated voltages stored in the EEPROM, if the sensed voltage is within 25% of the voltage level for a force applied condition, then the sensor is deemed to have been activated. Additionally the actual force is then also measured to allow a pressure value to be available to the reader software. In this example, the different sense inputs are applied as follows: —

Grip (all sensors show in increase in pressure)—scan according to the scan mode
Thumb pressure only—upload the data to the attached host
Little finger pressure only—change scan mode, such as from ‘scan-only-while-grip-pressure-is-applied’ to ‘scan-continuously-between-successive-grip-pressure-applied-cycles’

Thus it will be appreciated that using a plurality of force sensors allows different functionality to be selected using force applied by different fingers or different parts of the hand.

Thus an example methodology includes receiving a signal at the processor from at least one force sensor and using the received signal to determine if a force applied to the at least one force sensor is above a predetermined threshold. If the force applied to the at least one force sensor is above the predetermined threshold, then activating the reader, typically to complete a read cycle.

Once the barcodes have been read, the reader will upload the barcodes to the attached host computer, either immediately or after having been read, or alternatively the barcodes will be stored in a batch which would then be uploaded upon sensing an upload trigger via thumb pressure as described above.

An example of the force sensors used are Flexiforce sensors from Tekscan, which are thin piezoresistive based, allow full range hand pressure sensing. The change in force results in a change in resistance, which is converted to a change in voltage. This voltage is converted to a digital value by the analog to digital converted. A Flexiforce sensor able to detect force of up to 1 pound (0.45 kg or 4.4 Newtons) over the surface area of 0.375 inches (9.53 mm) will be used to sense the resultant grip or finger force. The sensor acts as a variable resistor in an electrical circuit. When the sensor is unloaded, its resistance is very high (greater than 5 Mega ohms); when a force is applied to the sensor, the resistance decreases. It can vary between 1000 ohms to 100 000 ohms, depending on the applied force.

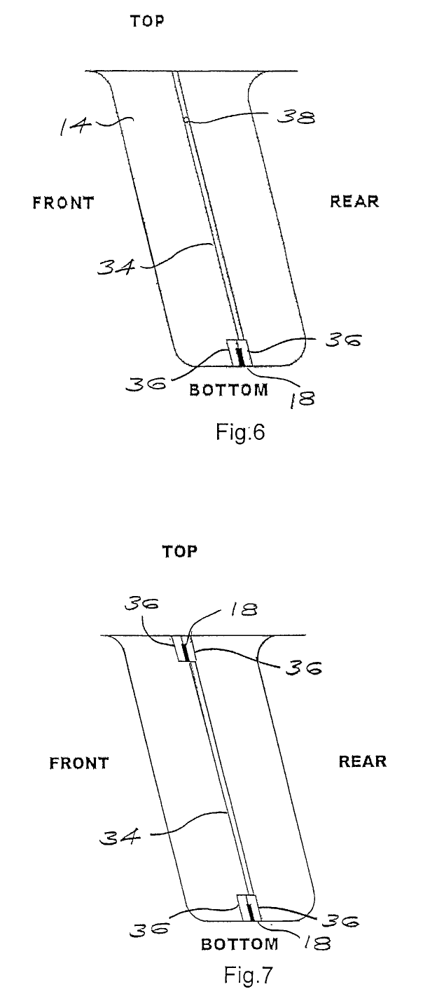

FIGS. 6 and 7 show second and third exemplary embodiments in which a single force sensor (FIG. 6) or two force sensors (FIG. 7) are used.

In both examples, the force applied between the front and rear parts of the bar code reader handle is sensed when the user effectively squeezes the front and rear part of the handle closely together.

A variety of methodologies can be used to sense this pressure or force such as using capacitive sensors, resistive force sensors or other methodologies.

In the illustrated embodiment, the front and rear halves of the handle was separated by a rubber gasket 34 with a suitable amount of flexibility to allow the front and rear halves to be squeezed together when applying hand pressure around the handle.

The flexible, tightly fitting rubber sheet is fitted around the handle which will be tight but not so tight as to cause the front and rear halves to be fully squeezed together without hand pressure.

Force sensors 18 such as the Tekscan Flexiforce sensors are used to sense the force applied.

The front and back halves of the handles have flanges 36 which are arranged so that they overlap exactly and press lightly against each other when no pressure is applied.

The force sensors are then mounted between each of the flanges.

In FIG. 6, where only a single bottom mounted force sensor is used, the front and rear halves of the handle are connected at a hinged point 38.

In both cases, an increase in pressure between the front and rear halves of the handle then results in the increase in pressure or force being sensed via a change in resistance, in this case causing a lowering of resistance. This results in the sensed voltage at the input of the analog to digital converter changing, which is in turn detected by the software monitoring the sensor voltage levels. Only one or two sensors are used in this example. The amount of force exerted between the front and rear halves can be used as a changeable user controlled input.

A further methodology (not illustrated) can use sensing air pressure, which will sense grip, hand or finger pressure resulting from displaced air when squeezing together a rubberised handle with air tight flexible air channels. A typical differential air pressure sensor, which senses the difference in air pressures from two inlets, will then effectively sense the squeezing of the handle.

The new method is based on sensing increasing hand force in one or more than one places, positions or areas on the handle used to hold a reader. This means that a user can initiate a scan or read as a result of an increase in grip force, or an increase in pressure or force of a single or multiple fingers around the handle.

A further method is to sense the variations of trigger force, resulting in an input control methodology, which will typically be used to change the scanning or reading functionality accordingly. For example, a softer pressure will indicate close range scanning at lower power; higher pressure will indicate long range scanning.

Increasing grip pressure is also more intuitive. In addition, more than one individually identifiable pressure sensing point can be accommodated, which again can be used in combination to trigger a scan, or individually to indicate different scans, such as RFID, barcode or scanning of both.

In summary, the fundamental principle is to sense grip, hand or finger pressure or force without use of a single finger operated trigger switch of any kind, and to use this force or pressure in order to trigger a barcode scan. A number of methodologies can be used to sense the force of a grip, hand or finger.

1. A reader including:
a housing;
at least one force sensor;
a reading module located in the housing, the reading module including a processor connected to the at least one force sensor to activate a read cycle when the at least one force sensor senses an applied force above a predetermined threshold.

2. A reader according to claim 1 wherein the reader includes a plurality of force sensors.

3. A reader according to claim 2 wherein the housing has a handle and wherein the sensors are located at various positions around the handle.

4. A reader according to claim 2 wherein the sensors are located at various positions around the housing.

5. A reader according to claim 2 wherein the at least one sensor is located beneath a layer of material.

6. A reader according to claim 5 wherein the layer of material is a rubber or plastic.

7. A reader according to claim 2 wherein at least one other force sensor is used to sense an applied force above a predetermined threshold and wherein the processor, in response to the detection of the applied force executes another function.

8. A reader according to claim 2 wherein at least one other force sensor is used to sense an applied force above a predetermined threshold and wherein the processor, in response to the detection of an applied force simultaneously on more than one of the sensors executes another function.

9. A reader according to claim 7 wherein the other function is at least one of: barcode read, RFID read, short range read and long range read.

10. A reader according to claim 1 wherein the at least one force sensors is a force resistor.

11. A reader according to claim 1 wherein the processor runs a calibration cycle to determine the output from the at least one sensor when a force is applied to the sensor.

12. A reader according to claim 1 wherein the reader is a bar code reader.

13. A reader according to claim 1 wherein the reader is an RFID reader.

14. A reader according to claim 3 wherein the handle has two parts with a space between them and wherein the at least one sensor is placed in the space so that a force applied to the handle is transmitted through the two handle parts to the at least one sensor.

15. A reader according to claim 1 wherein the force sensor is an air pressure sensor.

16. A method of activating a reader including:
receiving a signal at a processor from at least one force sensor;
using the received signal to determine if a force applied to the at least one force sensor is above a predetermined threshold; and
if the force applied to the at least one force sensor is above the predetermined threshold, then activating the reader.

17. A method according to claim 16 wherein the reader is activated to complete a read cycle.

18. A method according to claim 16 wherein the reader includes a plurality of force sensors and wherein the processor, in response to the detection of an applied force on one of the sensors executes a function.

19. A method according to claim 16 wherein the processor, in response to the detection of an applied force simultaneously on more than one of the sensors executes a function.

20. A method according to claim 18 wherein the function is at least one of: barcode read, RFID read, short range read and long range read.
